(19) United States
(12) Patent Application Publication
(10) Pub. No.: US 2026/0219122 A1
(43) Pub. Date: Jul. 30, 2026

(54) PRESSURE SENSOR AND REFRIGERATION SYSTEM

(71) Applicant: FUJI ELECTRIC CO., LTD., Kanagawa (JP)

(72) Inventors: Eisuke SATO, Matsumoto-city (JP); Fumiya UENO, Matsumoto-city (JP)

(21) Appl. No.: 19/399,444

(22) Filed: Nov. 24, 2025

(30) Foreign Application Priority Data
Jan. 30, 2025 (JP) 2025-014289

(51) Int. Cl. G01L 19/06; F25B 49/00; G01L 9/00; G01L 9/06; G01L 19/00

(52) U.S. Cl. CPC G01L 19/069; F25B 49/005; G01L 9/0054; G01L 9/06; G01L 19/0007

(57) ABSTRACT

To provide a pressure sensor comprising: a sensor portion, which is connected to a first pressure measurement hole into which a fluid flows in, and has a detector plane which detects pressure of the fluid; and a first reference potential portion that is conductive, which is provided between the first pressure measurement hole and the detector plane so as to be opposed to the detector plane, and is connected to a reference potential. In the pressure sensor, a distance between the first reference potential portion and the detector plane may be 1 cm or less. The first reference potential portion may be a mesh in which a plurality of wires are crossed.

The contents of the following patent application(s) are incorporated herein by reference:

NO. 2025-014289 filed in JP on January 30, 2025.

### BACKGROUND

### 1. Technical Field

The present invention relates to a pressure sensor and a refrigeration system.

### 2. Related Art

Patent Document 1 describes a pressure detection device which prevents incursion of foreign bodies or the like.

Patent Document 1: Japanese Patent Application Publication No. 2018-179624

### BRIEF DESCRIPTION OF THE DRAWINGS

FIG. 1 is a view showing one example of a refrigeration system 500 to which pressure sensors 100 in an example of the present invention are attached.

FIG. 2 is a schematic view showing a vicinity of a pressure sensor 100-1 in FIG. 1.

FIG. 3 is a schematic view showing a vicinity of a pressure sensor 200 in a comparative example.

FIG. 4A is a view showing one example of a cross-sectional shape of a first reference potential portion 31.

FIG. 4B is a view showing another example of a cross-sectional shape of the first reference potential portion 31.

FIG. 5 is a schematic view showing a variant of the pressure sensor 100-1.

FIG. 6 is a view showing one example of the refrigeration system 500 to which a pressure sensor 300 in another example is attached.

FIG. 7 is a schematic view showing a vicinity of the pressure sensor 300 in FIG. 6.

FIG. 8A is a schematic view showing a variant of the pressure sensor 100.

FIG. 8B is a schematic view showing another variant of the pressure sensor 100.

FIG. 9 is a schematic view showing a vicinity of a pressure sensor 100-1 and a pressure sensor 100-2 in FIG. 1.

### DESCRIPTION OF EXEMPLARY EMBODIMENTS

The present invention will be described below through embodiments of the invention, but the following embodiments do not limit the invention according to the claims. In addition, not all combinations of features described in the embodiments are necessarily essential to a solution of the invention. Note that, in the present specification and the drawings, a repeated description for an element having a substantially same function and configuration is omitted by providing a same reference numeral, and illustration of an element which is not directly associated with the present invention is omitted. In addition, for elements having substantially a same function and configuration in one drawing, a reference numeral may be given to an element as a representative, and for the rest of the elements, the reference numeral may not be given.

In the present specification, technical matters may be described by using orthogonal coordinate axes of an X axis, a Y axis, and a Z axis. The orthogonal coordinate axes merely specify relative positions of components, and do not limit a specific direction. For example, the Z axis is not limited to indicate the height direction with respect to the ground. Note that a +Z axis direction and a -Z axis direction are directions opposite to each other. When a Z axis direction is described without describing the signs, it means that the direction is parallel to a +Z axis and a -Z axis.

In the present specification, when terms such as "same," "equal," "parallel," or "perpendicular" are described, it may also include a case in which there is an error due to manufacturing variations or the like. The error is, for example, within 10%.

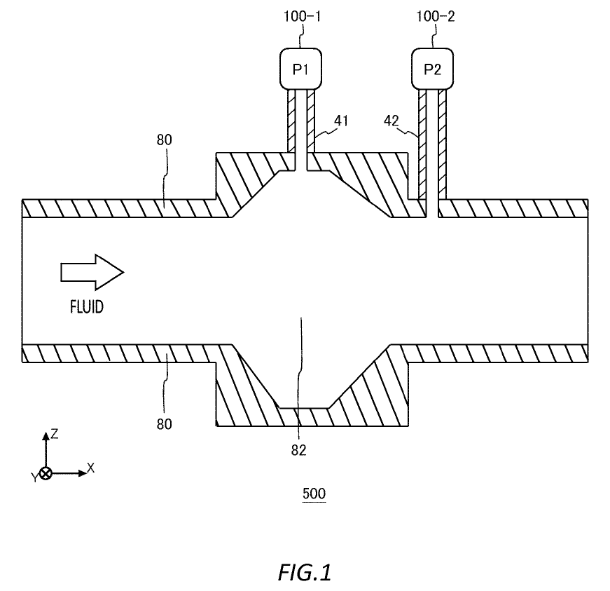

FIG. 1 is a view showing one example of a refrigeration system 500 to which pressure sensors 100 in an example of the present invention are attached. The refrigeration system 500 is, for example, a heat management system for xEVs such as electric vehicles (EVs), hybrid electric vehicles (HEVs), plug-in hybrid electric vehicles (PHEVs), fuel cell vehicles (FCVs), or the like. Note that, the refrigeration system 500 is one example, and the pressure sensors 100 may be widely used in the application of measuring pressure of a fluid. The pressure sensors 100 of the present example are provided in order to calculate a volumetric flow rate of a fluid that flows through the refrigeration system 500.

The refrigeration system 500 includes a main pipe 80, a first pressure measurement hole 41, and pressure sensors 100. The refrigeration system 500 may further include a second pressure measurement hole 42. The main pipe 80 has a main flow channel 82. The main flow channel 82 is a flow channel which allows the fluid (coolant) of the refrigeration system 500 to flow. In FIG. 1, the fluid flows from a negative side of an X axis to a positive side of the X axis. FIG. 1 shows a cross section parallel to a flow direction (X axis direction) in a vicinity of the pressure sensors 100 in the refrigeration system 500.

The first pressure measurement hole 41 and the second pressure measurement hole 42 are provided at the main pipe 80. The fluid flows in into the first pressure measurement hole 41 and the second pressure measurement hole 42 from the main pipe 80. The first pressure measurement hole 41 of the present example is provided at an upstream side of the main flow channel 82 from the second pressure measurement hole 42. The pressure sensors 100 are connected to the main pipe 80 by the pressure sensors 100 being connected to the pressure measurement holes. In the present example, the pressure sensor 100-1 is connected to the first pressure measurement hole 41, and the pressure sensor 100-2 is connected to the second pressure measurement hole 42. The pressure sensor 100-1 detects pressure of the fluid at a position of the first pressure measurement hole 41. The pressure sensor 100-2 detects pressure of the fluid at a position of the second pressure measurement hole 42.

A cross-sectional area of the main flow channel 82 at the position of the first pressure measurement hole 41 is different from a cross-sectional area of the main flow channel 82 at the position of the second pressure measurement hole 42. By changing the cross-sectional area of the flow channel, a flow speed of the fluid changes, to thereby cause a pressure difference. The cross-sectional area of the flow channel is an area of the main flow channel 82 in a cross section perpendicular to a flow direction of the fluid (in FIG. 1, a YZ cross section). In the present example, by making the main flow channel 82 narrow at the position of the second pressure measurement hole 42 to thereby decrease the cross-sectional area, the flow speed is increased, and pressure at the position of the second pressure measurement hole 42 becomes lower than pressure at the position of the first pressure measurement hole 41. This pressure difference is measured, and a simultaneous equation of a Bernoulli’s theorem and a continuity equation can be solved to thereby calculate a volumetric flow rate (a method for measuring the volumetric flow rate utilizing the Venturi effect).

According to the present approach, the volumetric flow rate can be measured with a simple configuration, in which only the pressure measurement holes are mounted at the main pipe 80. In this way, clogging or the like of the flow channel can be detected before a component of the refrigeration system 500 is broken.

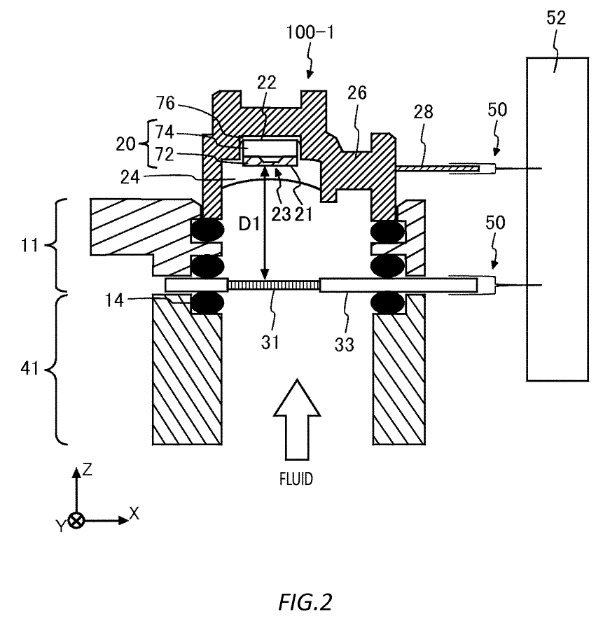

FIG. 2 is a schematic view showing a vicinity of a pressure sensor 100-1 in FIG. 1. FIG. 2 is a cross-sectional view of the pressure sensor 100-1 and the first pressure measurement hole 41. The pressure sensor 100-1 is connected to the first pressure measurement hole 41. The pressure sensor 100-1 of the present example is an absolute pressure sensor. Note that, the pressure sensor 100-2 may also have a similar configuration.

The pressure sensor 100-1 includes a sensor portion 20. The sensor portion 20 is a portion which detects the pressure of the fluid. The pressure sensor 100-1 of the present example is a semiconductor piezoresistance type pressure sensor.

The sensor portion 20 of the present example has a sensor chip 72 and a base substrate 74. To the base substrate 74, the sensor chip 72 is fixed. The base substrate 74 may be formed of glass or the like.

The sensor chip 72 is a pressure sensor chip formed of a semiconductor such as silicon. Space is formed in the sensor chip 72 of the present example, and a diaphragm obtained by thinning silicon is arranged on the space.

The sensor portion 20 has a detector plane 23. The detector plane 23 may be a portion where a state such as a shape, a resistance value, or a charge amount is changed by receiving the pressure of the fluid. The detector plane 23 may be a portion which detects the pressure according to the change of the above-described state. The detector plane 23 of the present example is a diaphragm. At the detector plane 23, a resistor portion (a strain gage) formed by injecting impurities may be formed. The detector plane 23 receives the pressure of the fluid that flows in from the first pressure measurement hole 41 to be deformed. Pressure is calculated from a change in a resistance value of the resistor portion due to the deformation (strain) of the detector plane 23. The detector plane 23 may be provided with a plurality of electrodes for measuring the change in the resistance value.

The sensor portion 20 may have a first main plane 21 and a second main plane 22. The first main plane 21 and the second main plane 22 are two main planes of the sensor portion 20. A plane on which the detector plane 23 is formed may be the first main plane 21. The plane on which the detector plane 23 is formed may be a plane that has a small distance to the detector plane 23 among the first main plane 21 and the second main plane 22. The first main plane 21 of the present example is a plane opposite to a plane fixed to the base substrate 74 among the main planes of the sensor chip 72. In FIG. 2, the detector plane 23 is flush with the first main plane 21. The second main plane 22 is a plane opposite to the first main plane 21. The second main plane 22 of the present example is a plane opposite to a plane to which the sensor chip 72 is fixed among the main planes of the base substrate 74.

The sensor portion 20 may have an integrated circuit (IC) which processes a detection signal of the detector plane 23. One example of the detection signal is an output voltage of a bridge circuit of the resistor portion. The IC may perform conversion, amplification, temperature compensation or the like on the detection signal. The IC may be provided on the plane on which the detector plane 23 is formed. The IC of the present example is provided on the first main plane 21.

The sensor portion 20 is fixed to a housing 26 with an adhesive 76. FIG. 2 shows a ground terminal 28 of the sensor portion 20. The housing 26 includes a power source terminal and an output terminal that are not illustrated, in addition to the ground terminal 28. The ground terminal 28 of the present example is connected to a reference potential line 52 via a terminal 50. As one example, the ground terminal 28 may be connected to the reference potential line 52 by by putting the terminal 50 into a socket of the reference potential line 52. The ground terminal 28 supplies a reference potential of a circuit provided at the sensor portion 20.

The sensor portion 20 is connected to the first pressure measurement hole 41. In the present example, the first connection portion 11 connects the housing 26 including the sensor portion 20 to the first pressure measurement hole 41. The fluid from the first pressure measurement hole 41 flows in into the flow channel of the first connection portion 11. O-rings 14 are provided at connection parts between the first connection portion 11 and the housing 26 and between the first connection portion 11 and the first pressure measurement hole 41.

The pressure sensor 100-1 includes the first reference potential portion 31. The first reference potential portion 31 is a conductive member connected to a reference potential. One example of the first reference potential portion 31 is a metallic mesh. The first reference potential portion 31 is provided between the first pressure measurement hole 41 and the detector plane 23 so as to be opposed to the detector plane 23. The first reference potential portion 31 being opposed to the detector plane 23 may include both a case where the first reference potential portion 31 faces the first main plane 21 and a case where the first reference potential portion 31 faces the second main plane 22. The first reference potential portion 31 of the present example faces the first main plane 21. Note that, when the first reference potential portion 31 faces the first main plane 21, a guard member 24 may be provided on the surface of the first main plane 21 in order to protect a bridge circuit or an IC of the detector plane 23.

The first reference potential portion 31 of the present example is attached to an outer frame 33 and at least one part is fixed at a position that is opposed to the detector plane 23. The first reference potential portion 31 is connected to the reference potential line 52. The first reference potential portion 31 of the present example is connected to the reference potential line 52 via the terminal 50, similarly to the ground terminal 28.

The fluid, which flows in into the sensor portion 20 from the first pressure measurement hole 41 via the first connection portion 11, convects in a vicinity of the sensor portion 20. Therefore, static electricity is generated in the vicinity of the sensor portion 20, and the sensor portion 20 is charged. The charged sensor portion 20 may cause malfunctions or measurement errors. By providing the first reference potential portion 31, the charged sensor portion 20 can be suppressed. In addition, measurement of a pulse of the fluid by the sensor portion 20 can be suppressed, and generation of an error due to the pulse can be suppressed.

The first reference potential portion 31 of the present example is provided between the first connection portion 11 and the first pressure measurement hole 41, but the first reference potential portion 31 may be provided at the first connection portion 11, and may be provided at the housing 26 of the pressure sensor 100-1. In addition, the first reference potential portion 31 may be provided at the first pressure measurement hole 41. In this case as well, the first reference potential portion 31 is positioned between a portion of the first pressure measurement hole 41 opposite to the detector plane 23 from the first reference potential portion 31 (in FIG. 2, a negative side of the Z axis), and the detector plane 23.

The pressure sensor 100-1 of the present example is a semiconductor piezoresistance type, but the pressure sensor 100-1 is not limited thereto. For example, the pressure sensor 100-1 may be a film resistance type pressure sensor having a metal resistance element, and may be an electrostatic capacity type pressure sensor. The pressure sensor 100-1 may be a pressure sensor having the detector plane 23. The detector plane 23 may be a metal diaphragm, and may be a thinned portion provided with a strain gage. Even in that case, the above-described similar effect can be obtained.

A distance D1 between the first reference potential portion 31 and the detector plane 23 may be 1 cm or less. As the distance D1 is smaller, an effect of suppressing charging is increased. The distance D1 may be a distance between the detector plane 23 and a position of a plane closest to the detector plane 23 among planes of the first reference potential portion 31. The distance D1 may be 0.8 cm or less, may be 0.6 cm or less, or may be 0.4 cm or less. The distance D1 may be 0.01 cm or more.

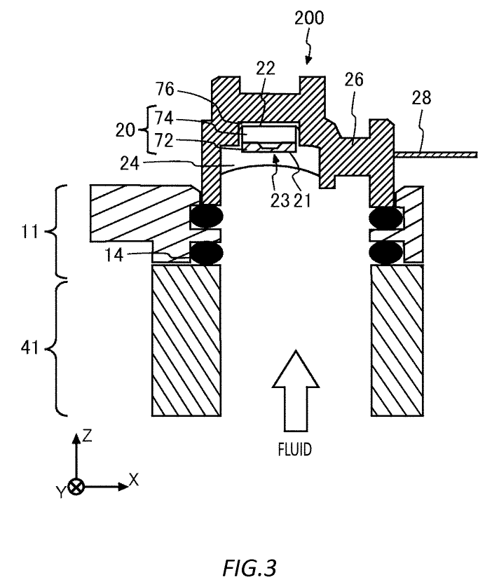

FIG. 3 is a schematic view showing a vicinity of a pressure sensor 200 in a comparative example. In FIG. 3, the reference potential line 52 shown in FIG. 2 is omitted. The pressure sensor 200 of the present example does not include the first reference potential portion 31. Therefore, compared to the pressure sensors 100 of the example, the sensor portion 20 is easily charged, which easily generates malfunctions or measurement errors. In addition, due to an influence due to a pulse of the fluid, a noise is easily superimposed on a detection signal.

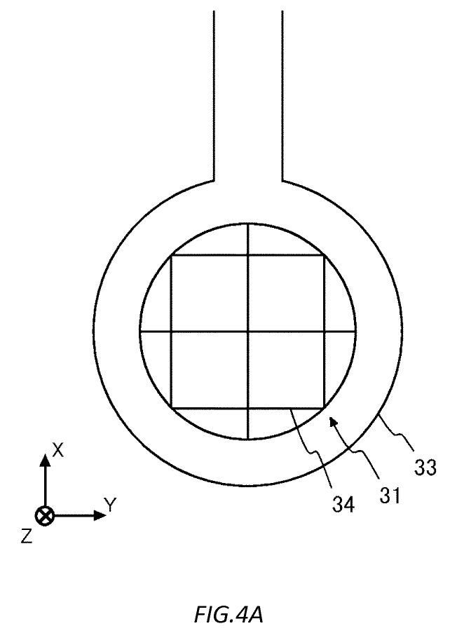

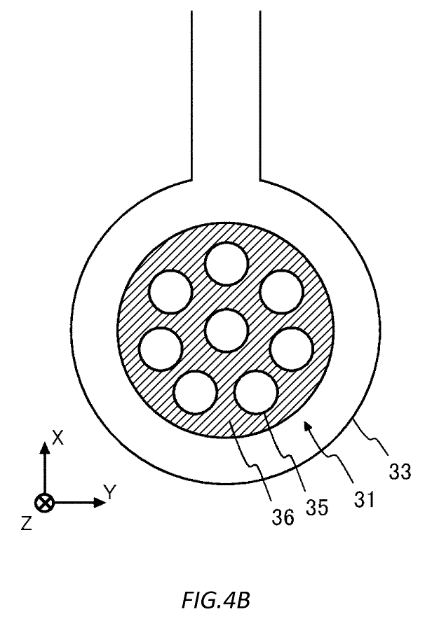

FIG. 4A is a view showing one example of a cross-sectional shape of a first reference potential portion 31. The first reference potential portion 31 of the present example is a mesh in which a plurality of wires 34 are crossed. The wires 34 may be metallic. The wires 34 of the present example are attached to the outer frame 33. The fluid flows between the wires 34 inside the outer frame 33. That is, the first reference potential portion 31 and the outer frame 33 of the present example are an orifice including a mesh.

A conductive member may be provided even inside the outer frame 33. The wires 34 are connected to the terminal 50 shown in FIG. 2 via the above-described member, and may be connected to the reference potential. Note that, an entire outer frame 33 may be formed of a metal.

FIG. 4B is a view showing another example of a cross-sectional shape of the first reference potential portion 31. The first reference potential portion 31 of the present example is a plate surface 36 in which a plurality of through holes 35 are provided. The plate surface 36 may be metallic. The fluid flows through the through holes 35. The plate surface 36 of the present example is attached to the outer frame 33. That is, the first reference potential portion 31 and the outer frame 33 of the present example are an orifice including a punching mesh.

A conductive member may be provided even inside the outer frame 33. The plate surface 36 is connected to the terminal 50 shown in FIG. 2 via the above-described member, and may be connected to the reference potential. Note that, an entire outer frame 33 may be formed of a metal.

In a cross-sectional drawing of the first reference potential portion 31, a portion through which the fluid can pass is referred to as an aperture. The aperture is a portion between the plurality of wires 34 in FIG. 4A or a portion of the through holes 35 in FIG. 4B. The first reference potential portion 31 has an aperture. A ratio of an area of apertures in a unit area is an aperture ratio. The aperture ratio shows a density of the meshes in FIG. 4A or a density of the through holes in FIG. 4B. The aperture ratio may be a ratio of the area of apertures relative to an area of an entire first reference potential portion 31.

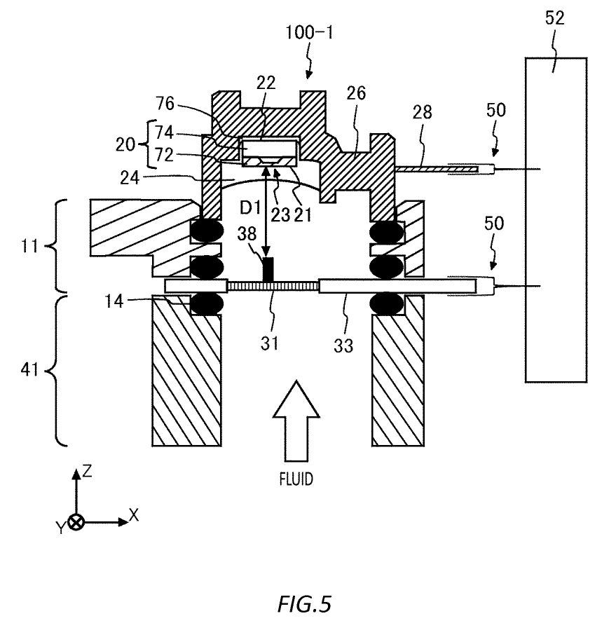

FIG. 5 is a schematic view showing a variant of the pressure sensor 100-1. FIG. 5 is a cross-sectional view of a same range as FIG. 2. The pressure sensor 100-1 of the present example is different from the pressure sensor 100-1 shown in FIG. 2 in that the first reference potential portion 31 has a protrusion 38.

The protrusion 38 is a portion that protrudes from the first reference potential portion 31 toward the detector plane 23. The protrusion 38 may be conductive. By providing the protrusion 38, a distance D1 between the first reference potential portion 31 and the detector plane 23 can be decreased, and the charged sensor portion 20 can be further suppressed. The distance D1 of the present example may be a distance from an edge of the protrusion 38 to the detector plane 23. The first reference potential portion 31 may have a plurality of protrusions 38.

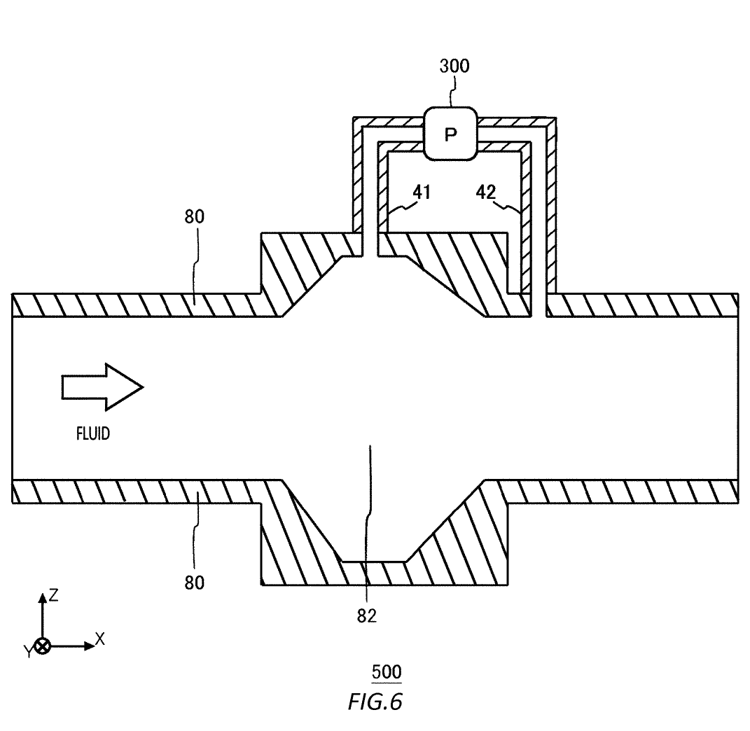

FIG. 6 is a view showing one example of the refrigeration system 500 to which a pressure sensor 300 in another example is attached. The pressure sensor 300 of the present example is a relative pressure sensor. The pressure sensor 300 of the present example measures a differential pressure between fluids at two points. Based on the measured differential pressure, a volumetric flow rate of the fluid that flows through the main flow channel 82 may be calculated. The pressure sensor 300 of the present example is connected to the first pressure measurement hole 41 and the second pressure measurement hole 42.

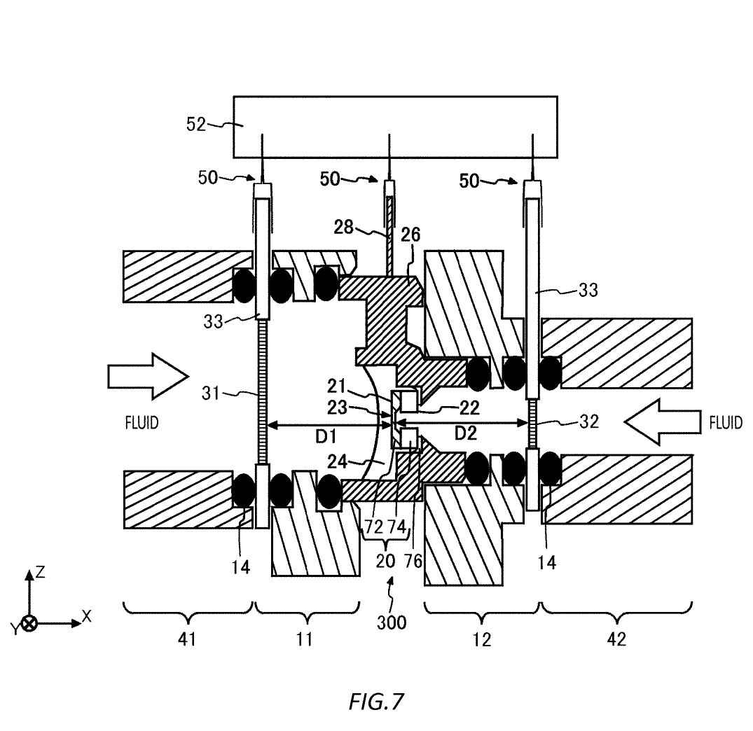

FIG. 7 is a schematic view showing a vicinity of the pressure sensor 300 in FIG. 6. FIG. 7 is a cross-sectional view of the pressure sensor 300, the first pressure measurement hole 41, and the second pressure measurement hole 42. Description of similar configurations of the pressure sensor 300 as those in FIG. 2 is appropriately omitted.

The pressure sensor 300 is connected to the first pressure measurement hole 41 and the second pressure measurement hole 42. In FIG. 7, a pressure measurement hole which faces the first main plane 21 of the sensor portion 20 is the first pressure measurement hole 41, and a pressure measurement hole which faces the second main plane 22 is the second pressure measurement hole 42. In the present example, the first connection portion 11 connects the sensor portion 20 to the first pressure measurement hole 41. In addition, the second connection portion 12 connects the sensor portion 20 to the second pressure measurement hole 42.

The pressure sensor 300 detects a differential pressure between fluid that flows in from the first pressure measurement hole 41 and fluid that flows in from the second pressure measurement hole 42. The first main plane 21 of the sensor portion 20 of the present example is provided with the guard member 24 which protects the sensor portion 20.

The pressure sensor 300 includes the first reference potential portion 31. The first reference potential portion 31 of the present example faces the first main plane 21 of the sensor portion 20. The first reference potential portion 31 of the present example is provided between the first connection portion 11 and the first pressure measurement hole 41 similar to FIG. 2, but arrangement of the first reference potential portion 31 is not limited thereto, similarly to FIG. 2.

The pressure sensor 300 may further include a second reference potential portion 32. The second reference potential portion 32 of the present example is a conductive member connected to a reference potential. One example of the second reference potential portion 32 is a metallic mesh. The second reference potential portion 32 is provided between the second pressure measurement hole 42 and the detector plane 23 so as to being opposed to the detector plane 23. The second reference potential portion 32 of the present example is attached to the outer frame 33 and at least one part is fixed at a position that is opposed to the detector plane 23.

The second reference potential portion 32 is connected to the reference potential line 52. The second reference potential portion 32 of the present example is connected to the reference potential line 52 via the terminal 50. By providing the second reference potential portion 32, the charged sensor portion 20 can be further suppressed.

The distance D1 between the first reference potential portion 31 and the detector plane 23 may be smaller than a distance D2 between the second reference potential portion 32 and the detector plane 23. The distance D2 may be a distance between the detector plane 23 and a position of a plane closest to the detector plane 23 among planes of the second reference potential portion 32. In this way, charging on the detector plane 23 and the side of the first main plane 21 on which an IC is formed can be further suppressed. Note that, the distance D1 may be equal to the distance D2. In addition, a value of the distance D2 may fall within a range of any of the values of the distance D1 described above.

A cross-sectional area of a flow channel of the first pressure measurement hole 41 may be different from a cross-sectional area of a flow channel of the second pressure measurement hole 42. In the present example, the cross-sectional area of the flow channel of the first pressure measurement hole 41 is larger than the cross-sectional area of the flow channel of the second pressure measurement hole 42. A cross-sectional area of the first reference potential portion 31 may be different from a cross-sectional area of the second reference potential portion 32. The cross-sectional areas of the first reference potential portion 31 and second reference potential portion 32 are areas seen from a flow direction (in FIG. 7, X axis direction). In the present example, the cross-sectional area of the first reference potential portion 31 is larger than the cross-sectional area of the second reference potential portion 32.

A cross-sectional shape of the second reference potential portion 32 may be similar to the cross-sectional shape of the first reference potential portion 31 shown in FIGS. 4A or FIG. 4B. That is, the second reference potential portion 32 may be a mesh in which a plurality of wires are crossed, or may be a plate surface in which a plurality of through holes are provided. The second reference potential portion 32 may have an aperture. The first reference potential portion 31 and the second reference potential portion 32 may be same materials.

An aperture ratio of the first reference potential portion 31 (see FIGS. 4A and FIG. 4B) may be smaller than an aperture ratio of the second reference potential portion 32. A pulse of the fluid described above increases at an upstream side of the main flow channel 82. When the first pressure measurement hole 41 is provided at an upstream side of the main flow channel 82 from the second pressure measurement hole 42, decreasing the aperture ratio of the first reference potential portion 31 can suppress an influence of a pulse at an upstream side where the influence of the pulse is large.

When the first reference potential portion 31 faces the first main plane 21, the aperture ratio of the first reference potential portion 31 may be smaller than the aperture ratio of the second reference potential portion 32. In this way, charging on the detector plane 23 and the side of the first main plane 21 on which an IC is formed can be further suppressed.

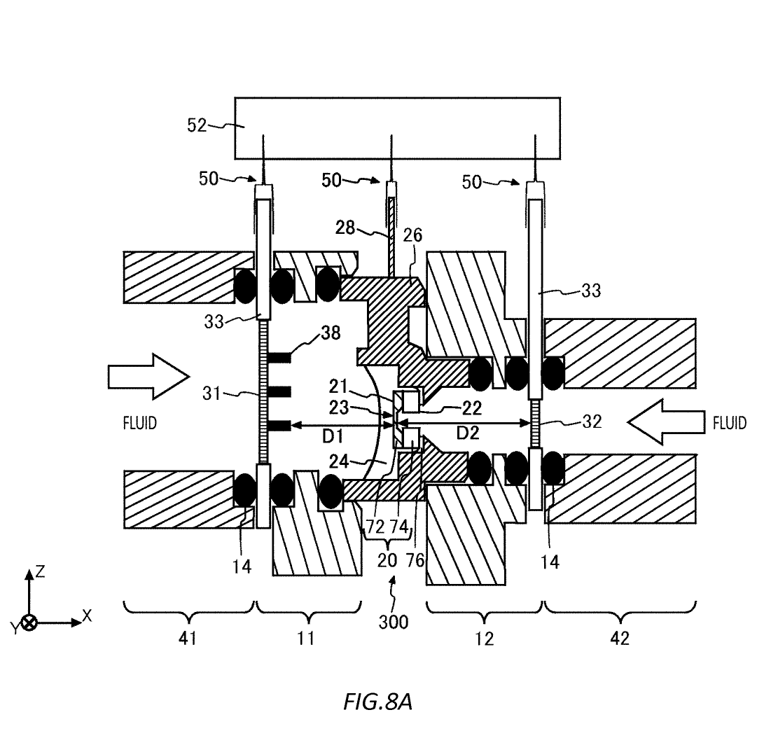

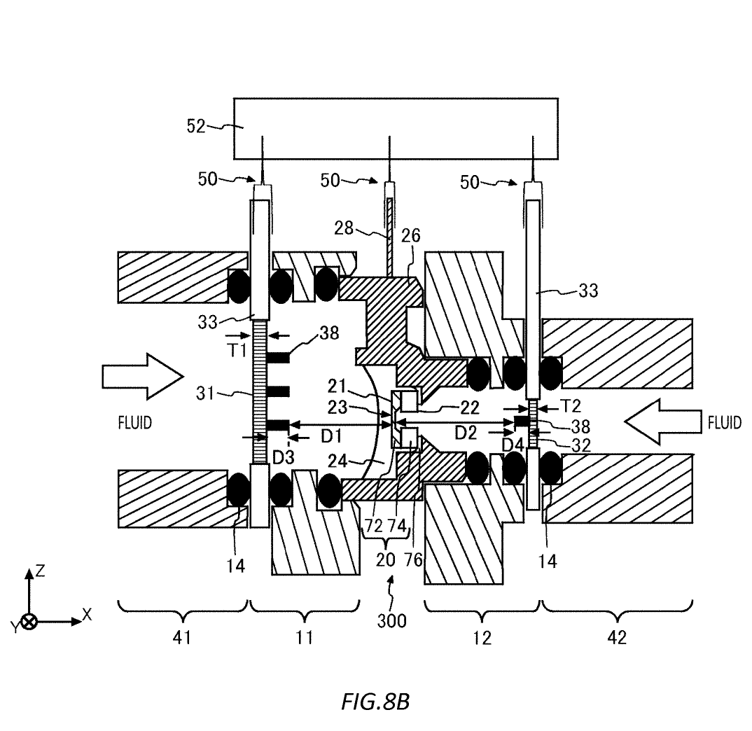

FIG. 8A is a schematic view showing a variant of the pressure sensor 300. FIG. 8A is a cross-sectional view of a same range as FIG. 7. Even in the present example, the first reference potential portion 31 faces the first main plane 21 of the sensor portion 20, and the second reference potential portion 32 faces the second main plane 22. The pressure sensor 300 of the present example is different from the pressure sensor 300 shown in FIG. 7 in that the first reference potential portion 31 has protrusions 38.

The protrusion 38 is a portion that protrudes from the first reference potential portion 31 toward the detector plane 23. The protrusion 38 may be conductive. By providing the protrusion 38, a distance D1 between the first reference potential portion 31 and the sensor portion 20 can be decreased, and the charged sensor portion 20 can be further suppressed. The distance D1 of the present example may be a distance from an edge of the protrusion 38 to the detector plane 23. The first reference potential portion 31 of the present example has a plurality of protrusions 38.

The second reference potential portion 32 of the present example has no protrusion 38. When the first reference potential portion 31 has the protrusion 38, charging on the detector plane 23 and the side of the first main plane 21 on which an IC is formed can be effectively suppressed.

FIG. 8B is a schematic view showing another variant of the pressure sensor 300. Even in the present example, the first reference potential portion 31 faces the first main plane 21 of the sensor portion 20, and the second reference potential portion 32 faces the second main plane 22. In the present example, the first reference potential portion 31 and the second reference potential portion 32 have protrusions 38. The protrusion 38 of the second reference potential portion 32 may be conductive. In this way,charging on the sensor portion 20 can be further suppressed. The second reference potential portion 32 may have a plurality of protrusions 38.

A length D3 of the protrusion 38 of the first reference potential portion 31 may be larger than a length D4 of the protrusion 38 of the second reference potential portion 32. Each length may be a length in a direction parallel to a flow direction (in FIG. 8B, X axis direction). In this way, charging on the detector plane 23 and the side of the first main plane 21 on which an IC is formed can be further suppressed.

A number of protrusions 38 of the first reference potential portion 31 may be greater than a number of protrusions 38 of the second reference potential portion 32. A density of the protrusions 38 of the first reference potential portion 31 may be greater than a density of the protrusions 38 of the second reference potential portion 32. In this way, charging on the detector plane 23 and the side of the first main plane 21 on which an IC is formed can be further suppressed.

A thickness T1 of the first reference potential portion 31 may be greater than a thickness T2 of the second reference potential portion 32. Each thickness may be a thickness in a direction parallel to the flow direction. In this way, charging on the detector plane 23 and the side of the first main plane 21 on which an IC is formed can be further suppressed.

In another example, instead of the second reference potential portion 32, a nonconductive pulse suppressing portion may be provided. In addition, instead of the second reference potential portion 32, a pulse suppressing portion which is not connected to the reference potential may be provided. A shape of the pulse suppressing portion may be similar to a shape of the second reference potential portion 32. Even in this case, the first reference potential portion 31 can suppress charging on the side of the first main plane 21, and the pulse suppressing portion can reduce the influence of the pulse of the fluid at a side of the second main plane 22. The cross-sectional area of the first reference potential portion 31 (see FIGS. 4A or FIG. 4B) may be greater than the cross-sectional area of the second reference potential portion 32. The above-described relationship may be optionally combined. In addition, another example or variant may be combined.

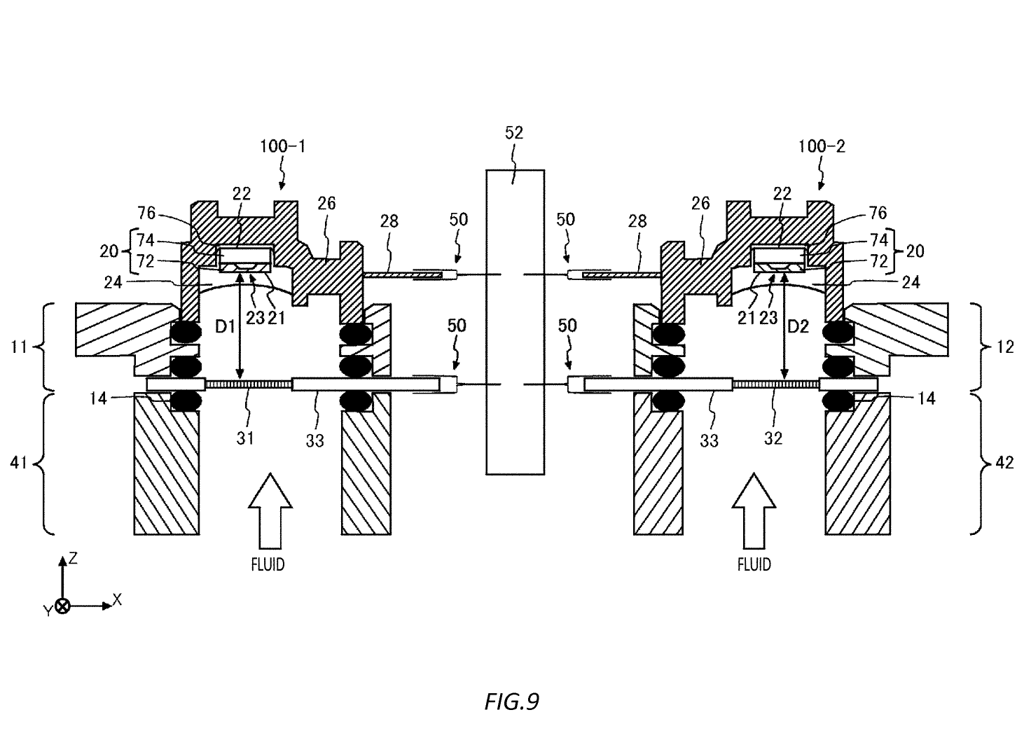

FIG. 9 is a schematic view showing a vicinity of a pressure sensor 100-1 and a pressure sensor 100-2 in FIG. 1. The pressure sensor 100-1 is connected to the first pressure measurement hole 41 by the first connection portion 11. The pressure sensor 100-2 is connected to the second pressure measurement hole 42 by the second connection portion 12. A configuration of the pressure sensor 100-1 is similar to that of FIG. 2. Both the pressure sensor 100-1 and the pressure sensor 100-2 are absolute pressure sensors.

The pressure sensor 100-1 of the present example has the first reference potential portion 31. The pressure sensor 100-2 of the present example has the second reference potential portion 32. The second reference potential portion 32 of the present example may be a similar configuration to the first reference potential portion 31 described in FIG. 2 or the like or the second reference potential portion 32 described in FIG. 7 or the like. When the pressure sensor 100-2 has the second reference potential portion 32, charging on the sensor portion 20 of the pressure sensor 100-2 can be suppressed. In addition, measurement of a pulse of the fluid by the sensor portion 20 of the pressure sensor 100-2 can be suppressed, and generation of an error due to the pulse can be suppressed.

A cross-sectional shape of the second reference potential portion 32 may be similar to the cross-sectional shape of the first reference potential portion 31 shown in FIGS. 4A or FIG. 4B. The matters described in FIGS. 2 to FIG. 8B may be true even in the present example. For example, even in the present example, the aperture ratio of the first reference potential portion 31 may be smaller than the aperture ratio of the second reference potential portion 32.

While the present invention has been described by way of the embodiments, the technical scope of the present invention is not limited to the scope of the above-described embodiments. It is apparent to persons skilled in the art that various alterations or improvements can be made to the above-described embodiments. It is also apparent from the description of the claims that the embodiments to which such alterations or improvements are made can fall within the technical scope of the present invention.

What is claimed is:

1. A pressure sensor comprising:
a sensor portion, which is connected to a first pressure measurement hole into which a fluid flows in, and has a detector plane which detects pressure of the fluid; and
a first reference potential portion that is conductive, which is provided between the first pressure measurement hole and the detector plane so as to be opposed to the detector plane, and is connected to a reference potential.

2. The pressure sensor according to claim 1,
wherein a distance between the first reference potential portion and the detector plane is 1 cm or less.

3. The pressure sensor according to claim 1,
wherein the first reference potential portion is a mesh in which a plurality of wires are crossed.

4. The pressure sensor according to claim 1,
wherein the first reference potential portion is a plate surface in which a plurality of through holes are provided.

5. The pressure sensor according to claim 1,
wherein the first reference potential portion has a protrusion extending toward the detector plane.

6. The pressure sensor according to claim 1,
wherein the pressure sensor is a relative pressure sensor.

7. The pressure sensor according to claim 6,
wherein the sensor portion is connected to a second pressure measurement hole into which the fluid flows in, and
wherein the pressure sensor comprises
a second reference potential portion that is conductive, which is provided between the second pressure measurement hole and the detector plane so as to be opposed to the detector plane, and is connected to a reference potential.

8. The pressure sensor according to claim 7,
wherein the sensor portion has
a first main plane on which the detector plane and an IC which processes a detection signal of the detector plane are formed; and
a second main plane opposite to the first main plane,
the first pressure measurement hole faces the first main plane, and the second pressure measurement hole faces the second main plane,
the first reference potential portion has a protrusion which extends toward the detector plane, and
the second reference potential portion does not have the protrusion.

9. The pressure sensor according to claim 7,
wherein the first pressure measurement hole and the second pressure measurement hole are provided at a main pipe having a main flow channel,
the first pressure measurement hole is positioned at an upstream side of the main flow channel from the second pressure measurement hole,
the first reference potential portion and the second reference potential portion have an aperture, and
an aperture ratio of the first reference potential portion is smaller than an aperture ratio of the second reference potential portion.

10. A refrigeration system comprising:
the pressure sensor according to claim 1;
the first pressure measurement hole; and
a main pipe at which the first pressure measurement hole is provided and which has a main flow channel through which the fluid flows.

11. The pressure sensor according to claim 2,
wherein the first reference potential portion has a protrusion extending toward the detector plane.

12. The pressure sensor according to claim 3,
wherein the first reference potential portion has a protrusion extending toward the detector plane.

13. The pressure sensor according to claim 4,
wherein the first reference potential portion has a protrusion extending toward the detector plane.

14. The pressure sensor according to claim 2,
wherein the pressure sensor is a relative pressure sensor.

15. The pressure sensor according to claim 3,
wherein the pressure sensor is a relative pressure sensor.

16. The pressure sensor according to claim 4,
wherein the pressure sensor is a relative pressure sensor.

17. A refrigeration system comprising:
the pressure sensor according to claim 2;
the first pressure measurement hole; and
a main pipe at which the first pressure measurement hole is provided and which has a main flow channel through which the fluid flows.

18. A refrigeration system comprising:
the pressure sensor according to claim 3;
the first pressure measurement hole; and
a main pipe at which the first pressure measurement hole is provided and which has a main flow channel through which the fluid flows.

19. A refrigeration system comprising:
the pressure sensor according to claim 4;
the first pressure measurement hole; and
a main pipe at which the first pressure measurement hole is provided and which has a main flow channel through which the fluid flows.

20. A refrigeration system comprising:
the pressure sensor according to claim 5;
the first pressure measurement hole; and
a main pipe at which the first pressure measurement hole is provided and which has a main flow channel through which the fluid flows.
